(19) United States
(12) Patent Application Publication
(10) Pub. No.: US 2024/0272458 A1
(43) Pub. Date: Aug. 15, 2024

(54) Glasses that Facilitate the Quick Exchange of Visual-Effect Lenses

(71) Applicant: Drups Co LLC, Fort Worth, TX (US)

(72) Inventors: Joseph Terndrup, Fort Worth, TX (US); Joshua Terndrup, Fort Myers, FL (US)

(21) Appl. No.: 18/169,317

(22) Filed: Feb. 15, 2023

(51) Int. Cl. G02C 9/04; G02C 5/02

(52) U.S. Cl. CPC G02C 9/04; G02C 5/02

(57) ABSTRACT

Glasses comprising a frame configured to secure a subframe such that subframe is substantially hidden behind the frame when the glasses are viewed from the front. The glasses may be part of a glasses set comprising a plurality of subframes and a plurality of pairs of lenses permanently fixed to the subframes such that another pair of lenses is chosen by exchanging one of the plurality of subframes for another one of the plurality of subframes. Alternatively, the glasses set may comprise a subframe and a plurality of lenses such that another pair of lenses is chosen by detaching the subframe from the frame, exchanging one of the plurality of pairs of lenses for another one of the plurality of pairs of lenses, and attaching the subframe back to the frame.

### FIELD OF THE INVENTION

The present invention relates generally to glasses, and, in particular, to glasses that facilitate the quick exchange of visual effect, tinted, shaded, prescription, and clear lenses.

### SCOPE OF THE PRIOR ART

Being called social animals, humans love a good party. However, some events demand special accessories to receive the full experience. For instance, rave parties, EDM (Electronic Dance Music) events, poi art performances, and music festivals are often accompanied by a variety of immersive visual effects. Such visual effects can be enhanced by wearing glasses containing kaleidoscope, diffraction, 3D lenses, multi-color tinted lenses, metallic tint, clear lenses, prescription lenses, shaded lenses, or other visual effect lenses. Thus, to receive the full experience, party enthusiasts must carry around multiple pairs of glasses in order to engage with each visual effect.

Furthermore, different tinted and colored lenses have been shown by recent scientific research to have various beneficial effects on people's moods. Thus, changing out lenses can provide a benefit to an individual.

Another use of glasses could be to change out various prescriptions of clear lenses. This could provide the benefit in a doctor's office of quickly trying on different prescriptions utilizing the same set of frames.

Finally, the ability to change out different styles of lenses offers the opportunity for a person to match their eyewear to their specific fashion needs. This may include unique designs printed on lenses, rhinestone, jewels or similar objects attached to lenses, or similar stylized lenses.

There is a need for a pair of glasses that facilitates quick exchanges among a plurality of visual effect, black-out, kaleidoscope, diffraction, 3D, multi-color tinted, clear, shaded, prescription, and metallic tint lenses in a manner that preserves an appearance of the frame.

### SUMMARY

The present disclosure satisfies the foregoing needs by providing, inter alia, glasses that facilitate the quick exchange of visual effect lenses.

One aspect of the present disclosure is directed at glasses comprising a frame having a wearer-facing surface and a front-facing surface, a subframe, and a pair of lenses, wherein the wearer-facing surface is configured to secure the subframe and wherein the subframe is substantially hidden behind the frame when the glasses are viewed from the front.

The pair of lenses may be a pair of visual effect lenses that provide one of a diffraction, kaleidoscope, and black-out visual effect. Alternatively, 3D, clear, multi-color tinted, metallic tint, and shaded lenses may be used. Yet alternatively, uniquely lens styles, prescription lenses, clear lenses, or other visual effect lenses may be used.

The pair of lenses may be permanently fixed to the subframe such that another pair of lenses is chosen by exchanging the subframe for another subframe.

The pair of lenses may be removably held in between the subframe and the frame such that another pair of lenses is chosen by detaching the subframe from the frame, exchanging the pair of lenses for another pair of lenses, and attaching the subframe back to the frame.

A bridge element on the subframe may aide with subframe detachment.

The wearer-facing surface may comprise a cavity configured to receive the subframe such that when the subframe is secured to the frame, the subframe is substantially hidden behind the frame when the glasses are viewed from front, left, right, top and bottom.

The wearer-facing surface may comprise a cavity configured to receive the subframe such that when the subframe is secured to the frame, the subframe is substantially hidden behind the frame when the glasses are viewed from front and the subframe is at least partially hidden behind the frame when the glasses are viewed from the left, right, top and bottom.

Another aspect of the present disclosure is directed at a glasses set comprising a frame having a wearer-facing surface and a front-facing surface, a plurality of subframes, and a plurality of pairs of lenses wherein the wearer-facing surface is configured to secure one of the plurality of subframes, one of the plurality of subframes is substantially hidden behind the frame when the glasses are viewed from the front, and another pair of lenses is chosen by exchanging one of the plurality of subframes for another one of the plurality of subframes.

The pair of lenses may be a pair of visual effect lenses that provide one of a diffraction, kaleidoscope, and black-out visual effect. Alternatively, 3D, clear, multi-color tinted, metallic tint, and shaded lenses may be used. Yet alternatively, uniquely lens styles, prescription lenses, clear lenses, or other visual effect lenses may be used.

Another aspect of the present disclosure is directed at a glasses set comprising a frame having a wearer-facing surface and a front-facing surface, a subframe, and a plurality of pairs of lenses wherein the wearer-facing surface is configured to secure the subframe, the subframe is substantially hidden behind the frame when the glasses are viewed from the front, and another pair of lenses is chosen by detaching the subframe from the frame, exchanging one of the plurality of pairs of lenses for another one of the plurality of pairs of lenses, and attaching the subframe back to the frame.

The pair of lenses may be a pair of visual effect lenses that provide one of a diffraction, kaleidoscope, and black-out visual effect.

### BRIEF DESCRIPTION OF THE DRAWINGS

The foregoing summary, as well as the following detailed description of preferred variations of the invention, will be better understood when read in conjunction with the appended drawings. For the purpose of illustrating the invention, there is shown in the drawings variations that are presently preferred. It should be understood, however, that the invention is not limited to the precise arrangements shown. In the drawings, where:

FIG. 1 shows an exploded view of a pair of glasses, according to an embodiment.

FIG. 2a shows the frame and an unsecured subframe, according to an embodiment.

FIG. 2b shows the frame and a secured subframe, according to an embodiment.

FIG. 3 shows a pair of glasses, according to an embodiment.

FIG. 4 shows a pair of glasses, according to another embodiment.

### DETAILED DESCRIPTION

Implementations of the present technology will now be described in detail with reference to the drawings, which are provided as illustrative examples so as to enable those skilled in the art to practice the technology. Notably, the figures and examples below are not meant to limit the scope of the present disclosure to any single implementation or implementations. Wherever convenient, the same reference numbers will be used throughout the drawings to refer to same or like parts.

Moreover, while variations described herein are primarily discussed in the context of glasses having visual effects lenses, it will be recognized by those of ordinary skill that the present disclosure is not so limited. In fact, the principles of the present disclosure described herein may be readily applied to glasses having any type of lenses.

In the present specification, an implementation showing a singular component should not be considered limiting; rather, the disclosure is intended to encompass other implementations including a plurality of the same component, and vice-versa, unless explicitly stated otherwise herein. Further, the present disclosure encompasses present and future known equivalents to the components referred to herein by way of illustration.

It will be recognized that while certain aspects of the technology are described in terms of a specific sequence of steps of a method, these descriptions are only illustrative of the broader methods of the disclosure and may be modified as required by the particular application. Certain steps may be rendered unnecessary or optional under certain circumstances. Additionally, certain steps or functionality may be added to the disclosed implementations, or the order of performance of two or more steps permuted. All such variations are considered to be encompassed within the disclosure disclosed and claimed herein.

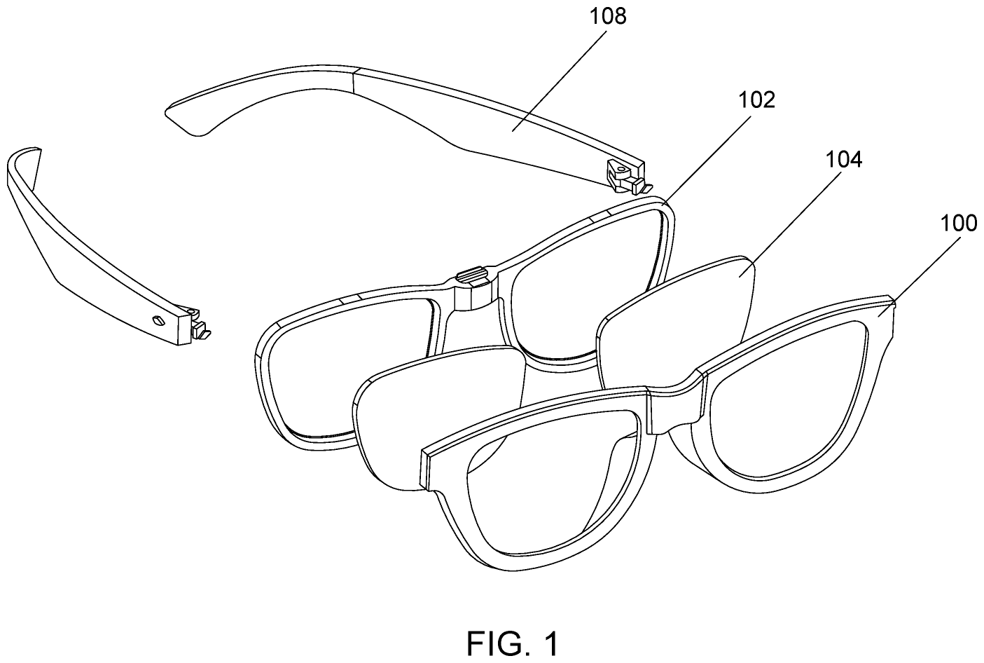

FIG. 1 shows an exploded view of a pair of glasses, according to an embodiment. The glasses comprise a frame 100, a subframe 102, a pair of lenses 104, and temples 106.

The frame 100 is shaped in an ordinary frame shape. The frame 100 has a wearer-facing surface that faces the wearer and a front-facing surface that faces away from the wearer.

The subframe 102 is shaped similar to the frame 100 and may share a same color or design as the frame 100. The subframe 102 attaches to the wearer-facing surface of the frame 100.

The pair of lenses 104 is permanently fixed to the subframe 102. Another pair of lenses is chosen by exchanging the subframe for another subframe.

Alternatively, the pair of lenses 104 may be removably held in between the subframe 102 and the frame 100 during ordinary use. Another pair of lenses is chosen by detaching the subframe from the frame, exchanging the pair of lenses for another pair of lenses, and attaching the subframe back to the frame.

The pair of lenses 104 is a pair of visual effect lenses such as a pair of diffraction, kaleidoscope, or black-out visual effect lenses, 3D lenses, clear lenses, multi-color tinted lenses, metallic tint, shaded lenses, unique lens styles, prescription lenses, clear lenses, or other visual effect lenses. Alternatively, the pair of lenses 104 may be a pair of tinted lenses such as a pair of pink, blue, or orange tinted lenses. Yet alternatively, the pair of lenses 104 may be a pair of custom lenses designed to match an outfit. Yet alternatively, the pair of lenses 104 may be a pair of therapeutic lenses designed to provide UV protection.

The temples 106 are coupled to the frame 100 using hinges or other coupling mechanisms.

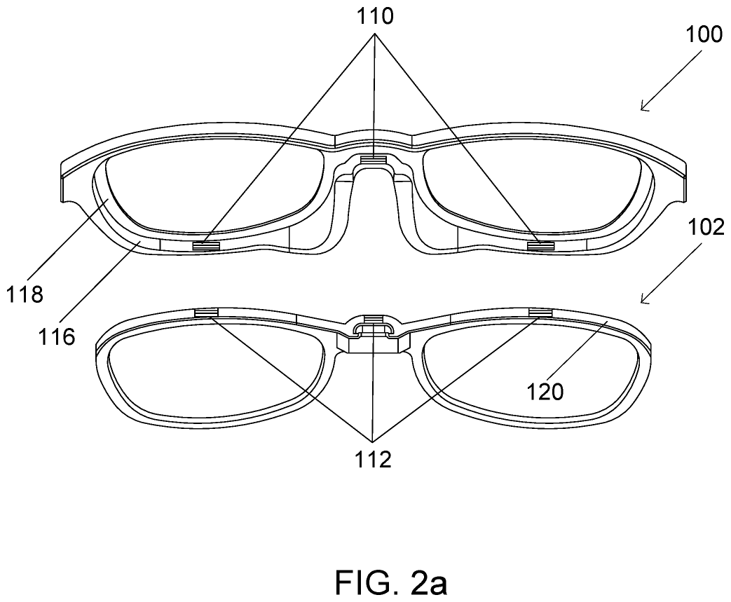

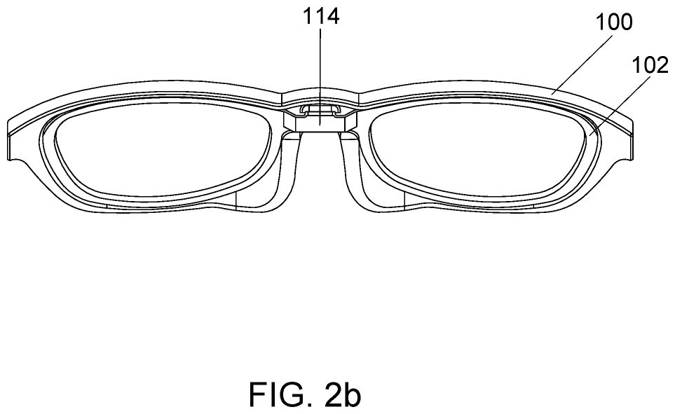

FIG. 2a shows the frame 100 and an unsecured subframe 102, according to an embodiment.

The wearer-facing surface of the frame 100 comprises a cavity configured to receive the subframe 102. The cavity wall 116 is substantially perpendicular to the wearer-facing surface and the cavity base 118 is substantially parallel to the wearer-facing surface. Alternatively, an angle in between the wearer-facing surface and the cavity wall 116 may be acute. The outer surface 120 of the subframe 102 is configured to lie flush with the cavity wall 116 when the subframe 102 is secured to the frame 100.

The frame 100 has a plurality of female snaps 110. Alternatively, the frame 100 has a plurality of magnetic units, sockets, or other first-part fastening mechanisms, or a combination thereof.

The female snaps 110 are positioned along the cavity wall 116. Alternatively, the female snaps 110 may be positioned on the cavity base 118.

The subframe 102 has a plurality of corresponding male snaps 112. Alternatively, the subframe 102 has a plurality of corresponding magnetic units, corresponding ball protrusions, or other corresponding second-part fastening mechanisms, or a combination thereof.

The male snaps 112 are positioned along the outer surface 120 of the subframe 102. Alternatively, the male snaps 112 may be positioned on the front-facing surface of the subframe 102 (not shown).

FIG. 2b shows the frame and a secured subframe, according to an embodiment.

The male snaps 112 are fastened to the female snape 120, securing the subframe 102 to the frame 100 such that the subframe 102 sits within a cavity of the frame 110.

The subframe 102 has a bridge element 114 that protrudes past the wearer-facing surface of the frame 100, facilitating easy and quick detachment of the subframe 102 from the frame 100.

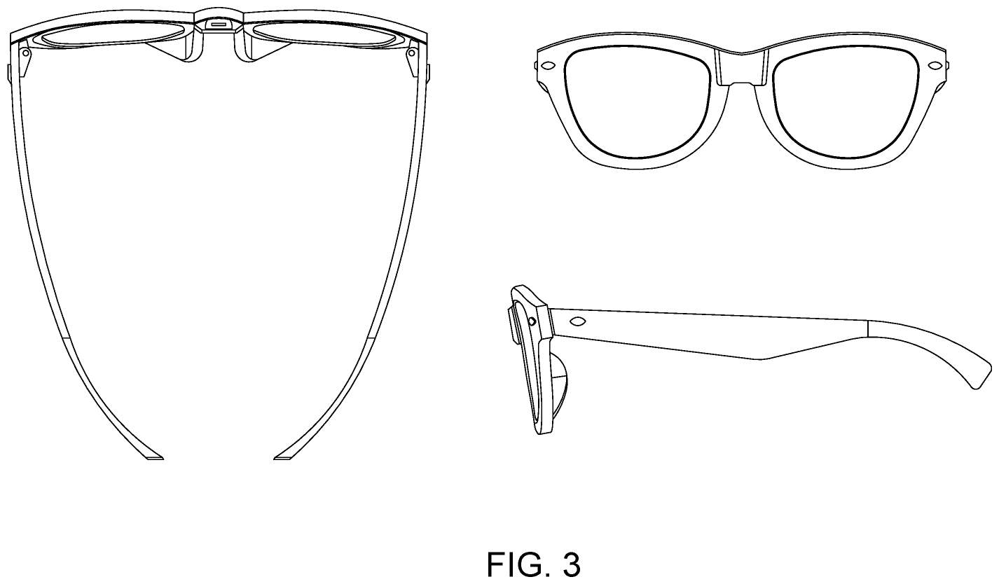

FIG. 3 shows a pair of glasses, according to an embodiment. The position of the subframe within the frame results in a pair of glasses where the subframe is substantially hidden behind the frame when the glasses are viewed from the front (as shown top right), from the right (as shown bottom right), from the left (not shown but a mirror image of the right), from the top (as shown on the left), and from the bottom (not shown). The subframe position advantageously preserves the appearance of the frame and facilitates the quick and easy exchange of visual effect lenses.

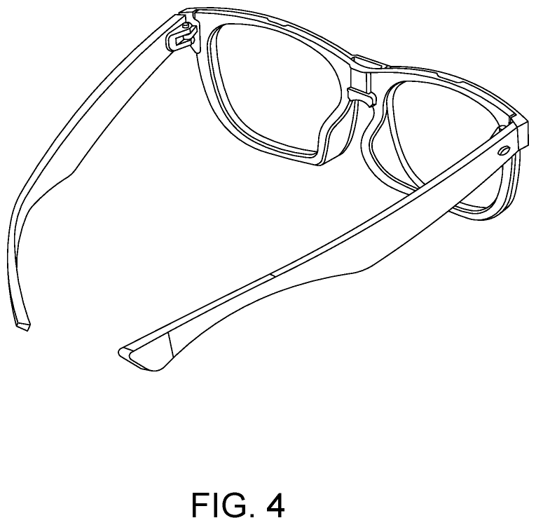

FIG. 4 shows a pair of glasses, according to another embodiment. The position of the subframe within the frame results in a pair of glasses where the subframe is substantially hidden behind the frame when the glasses are viewed from the front (not shown) and the subframe is at least partially hidden behind the frame when the glasses are viewed from the left, right, top and bottom (not shown). This subframe position advantageously causes minimal disruption to the appearance of the frame and facilitates the quick and easy exchange of visual effect lenses.

While the above detailed description has shown, described, and pointed out novel features of the disclosure as applied to various embodiments, it will be understood that various omissions, substitutions, and changes in the form and details of the device or process illustrated may be made by those skilled in the art without departing from the disclosure. The foregoing description is of the best mode presently contemplated of carrying out the principles of the disclosure. This description is in no way meant to be limiting, but rather should be taken as illustrative of the general principles of the technology. The scope of the disclosure should be determined with reference to the claims.

I claim:

1. Glasses comprising:
a frame having a wearer-facing surface and a front-facing surface;
a subframe;
a pair of lenses;
wherein
the wearer-facing surface is configured to secure the subframe; and
the subframe is substantially hidden behind the frame when the glasses are viewed from the front.

2. The glasses of claim 1, wherein the pair of lenses is a pair of visual effect lenses.

3. The glasses of claim 2, wherein the pair of visual effect lenses are one of diffraction lenses, kaleidoscope lenses, black-out lenses, 3D lenses, multi-color tinted lenses, metallic tint lenses, and shaded lenses.

4. The glasses of claim 1, wherein
the pair of lenses is permanently fixed to the subframe; and
another pair of lenses is chosen by exchanging the subframe for another subframe.

5. The glasses of claim 1, wherein
the pair of lenses is removably held in between the subframe and the frame; and
another pair of lenses is chosen by detaching the subframe from the frame, exchanging the pair of lenses for another pair of lenses, and attaching the subframe back to the frame.

6. The glasses of claim 1, wherein a bridge element on the subframe aids with subframe detachment.

7. The glasses of claim 1, wherein
the wearer-facing surface comprises a cavity configured to receive the subframe; and
when the subframe is secured to the frame, the subframe is substantially hidden behind the frame when the glasses are viewed from front, left, right, top and bottom.

8. The glasses of claim 7, wherein the pair of lenses is a pair of visual effect lenses.

9. The glasses of claim 8, wherein the pair of visual effect lenses is one of diffraction lenses, kaleidoscope lenses, black-out lenses, 3D lenses, multi-color tinted lenses, metallic tint lenses, and shaded lenses.

10. The glasses of claim 7, wherein a bridge element on the subframe aids with subframe detachment.

11. The glasses of claim 1, wherein
the wearer-facing surface comprises a cavity configured to receive the subframe;
when the subframe is secured to the frame, the subframe is substantially hidden behind the frame when the glasses are viewed from front and the subframe is at least partially hidden behind the frame when the glasses are viewed from the left, right, top and bottom.

12. The glasses of claim 11, wherein the pair of lenses is a pair of visual effect lenses.

13. The glasses of claim 12, wherein the pair of visual effect lenses is one of diffraction lenses, kaleidoscope lenses, black-out lenses, 3D lenses, multi-color tinted lenses, metallic tint lenses, and shaded lenses.

14. The glasses of claim 11, wherein a bridge element on the subframe aids with subframe detachment.

15. A glasses set comprising:
a frame having a wearer-facing surface and a front-facing surface;
a plurality of subframes;
a plurality of pairs of lenses;
wherein
the wearer-facing surface is configured to secure one of the plurality of subframes;
one of the plurality of subframes is substantially hidden behind the frame when the glasses are viewed from the front; and
another pair of lenses is chosen by exchanging one of the plurality of subframes for another one of the plurality of subframes.

16. The glasses set of claim 15, wherein the pair of lenses is a pair of visual effect lenses.

17. The glasses set of claim 16, wherein the pair of visual effect lenses is one of diffraction lenses, kaleidoscope lenses, black-out lenses, 3D lenses, multi-color tinted lenses, metallic tint lenses, and shaded lenses.

18. A glasses set comprising:
a frame having a wearer-facing surface and a front-facing surface;
a subframe;
a plurality of pairs of lenses;
wherein
the wearer-facing surface is configured to secure the subframe;
the subframe is substantially hidden behind the frame when the glasses are viewed from the front; and
another pair of lenses is chosen by detaching the subframe from the frame, exchanging one of the plurality of pairs of lenses for another one of the plurality of pairs of lenses, and attaching the subframe back to the frame.

19. The glasses set of claim 18, wherein the pair of lenses is a pair of visual effect lenses.

20. The glasses set of claim 19, wherein the pair of visual effect lenses is one of one of diffraction lenses, kaleidoscope lenses, black-out lenses, 3D lenses, multi-color tinted lenses, metallic tint lenses, and shaded lenses.
